(19) United States
(12) Patent Application Publication
(10) Pub. No.: US 2018/0139299 A1
(43) Pub. Date: May 17, 2018

(54) Method and System for Management of Universal Client Service Statuses

(71) Applicants: Mohamad Khatib, Wesley Chapel, FL (US); Jaspal Singh, Wesley Chapel, FL (US)

(72) Inventors: Mohamad Khatib, Wesley Chapel, FL (US); Jaspal Singh, Wesley Chapel, FL (US)

(21) Appl. No.: 15/350,131

(22) Filed: Nov. 14, 2016

(51) Int. Cl. H04L 29/08

(52) U.S. Cl. CPC H04L 67/24; H04L 67/22

(57) ABSTRACT

A method and system for managing interactions between service providers and client users via the internet. Service providers use the service provider application to define services they provide to their clients and configure their flow based on the universal services model, to initiate a new service instance, and to update service statuses. Client users interact with service providers using the client user application to view service statuses and input requested client feedback to progress their services. Client users view and interact with statuses of all the services they receive from various service providers from one client user application.

### TECHNICAL FIELD

This invention relates to a computer method and system for managing interactions between service providers and clients, more particularly, a method and system using a universal services model to represent all types of service statuses of all types of client services for all types of service providers, and to manage interactions between service providers and client users.

### BACKGROUND OF THE INVENTION

Services constitute a major part of the global economy. Over the years, various studies were carried out to conceptualize service operations management. Frameworks were developed to represent services, and document how service processes describe the flow of services.

Many successful implementations were applied by large organizations to model and automate services they provide to their clients. Such implementations applied only to specific service processes of these large organizations who can afford sufficient investments needed to complete such large scale implementations.

While this ad-hoc approach served large organizations, the mass bulk of small and medium sized service providers could not afford such implementations to introduce such automation.

The presented invention is aimed to simplify service status reporting and interaction management, and applies to all types of organizations with a simplified model for representing their service statuses.

The presented invention comprises a universal services model that can be easily utilized by all types of service providers. The invention also comprises application systems for service providers and for client users to manage the interactions.

This invention will serve as the foundation for modeling and automating the organization (Business) to clients (Consumers) interactions. Using a unified application, service providers can initiate and update service statuses for their clients. Using one application, a client user view statuses and interacts with various services providers.

### BRIEF SUMMARY OF THE INVENTION

The invention presents a method and system for managing interactions between service providers and client users.

The invention includes a universal service model with which all types of services can be easily modeled. The model provides a simple and powerful approach to represent services to comprise of statuses and actions.

The invention also includes application systems for services providers and for client users.

Service provider use the invention to define and configure services they provide using the universal service model.

Then they initiate services, and update statuses using the application.

Client users are able to track all services they receive by various providers in on application. The invention aggregates all services that a client receive from various service providers into one view for client to view, track and provide updates and feedback to the services they are subject for.

### BRIEF DESCRIPTION OF THE DRAWINGS

FIG. 1 Universal service model, showing the elements of a service comprising of Status and Action.

FIG. 2 Service Provider Registration screen, where service providers register to use the system.

FIG. 3 Service Definition and Configuration screen, where a service provider defines their services and configure the flow of services and client interactions.

FIG. 4 Service Provider Status Update screen, where a service provider takes actions to update status of a service they are delivering to their clients.

FIG. 5 Service Status and History Details screen, where a service provider can view details completed and archived services.

FIG. 6 Client user registration screen, where client users can register to use the system.

FIG. 7 Client user Active Services Status screen, where client users view all their active services from one application.

FIG. 8 Client user detailed services status and Actions display screen.

FIG. 9 Client user Completed Services screen, where client users view all their completed services from one application.

FIG. 10 Client user configuration and privacy settings where client users can configure their views of the system, and enter privacy settings for views and notification levels.

FIG. 11 Client user Service Blocking and Feedback, where client users can block unwanted service providers, and provide feedback.

### DETAILED DESCRIPTION OF THE INVENTION

The invention is a method and an online system for universal client user services management that enables unified tracking of all types of client user services from a single application.

The invention introduces a universal service model, as the model for all types of client user services, which enables tracking of service statuses and client user interactions.

The universal service model represent client service as Statuses and Actions. A service process always starts in an initiate state. Actions will transform the Status from one state to another, which leads to a service completion/end state. The universal service model enables client users to view all services provided to them by various service providers, from one unified view.

The system identifies a service provider as any business, organization, group, or individual who aims to provide any type of services to client users. For service providers, the universal service model simplifies the process of service definitions and allows service providers the ability to connect and interact with their client users in an easy and seamless manner.

The system enables service providers to configure various types of services that they offer to their client users, and initiate instances of such services whenever they occur. Service providers can update the status of service instances using a seamless and simplified mechanism. Once an instance of these services is initiated, it is automatically displayed on corresponding client's user application.

For Client users, they are immediately notified with services related to them, and have immediate access to status and progress information to the service being carried out by the service providers for them. Client users are also able to provide required input to service providers using their client user application.

The system includes following components:

### Universal Service Model

The universal service model is an innovative model to represent client user services for the purposes of capturing service status and actions information.

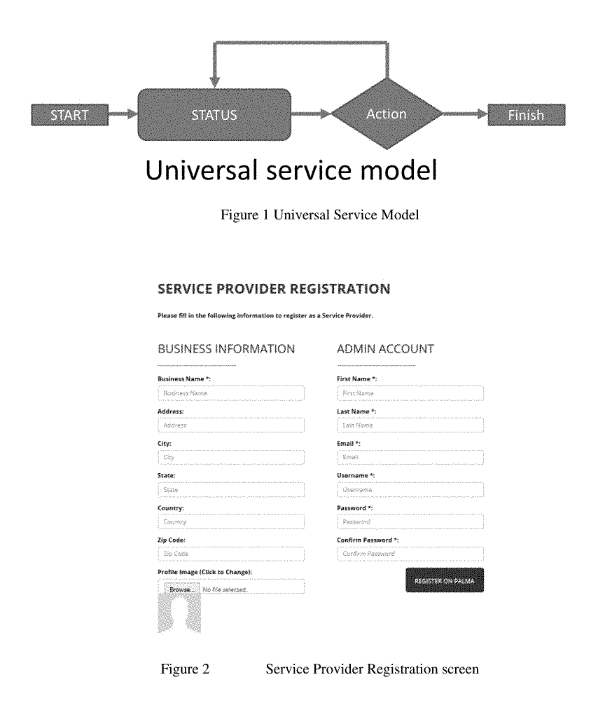

FIG. 1 Shows the Universal Service Model

The universal service model comprises following items:
a) A Service: is defined as a value added set of activities to fulfill client user requirements. These activities involve one or more client users, and results in fulfillment of client user requirements.
   A Service can be designated as:
      a. Private services, which are carried out for a specific client user or client user-group. Status and activities of Private services are of no interest or impact on other client users.
      b. Public services, which are extended for the public. Individuals are not pre-determined before the service is initiated.
b) Service Status: a state for a service, which describes the state in the process of fulfilling required client user service.
   Each service, by default, will have 2 default states:
      1. Initiate: is the initial state of the service. Once a service instance is started, it goes into the Initiate state.
         It is the starting state of the process, and service providers can configure the name of such state in whatever title that suites their services.
         In addition, service providers will configure the appropriate actions that can apply to this Initiate state, which will transform the status of the service to other subsequent states.
      2. Complete: is the final state of a service, and indicates that the service has been concluded. Service providers are able to create additional services statuses that best describes the flow of services they provide to their client users.
c) Service Actions: valid actions that can be carried out on the current state which progress the service. An Action will transform a service from one state to another. It indicates the progress in the process of the service. Actions can be carried out by operators of the Service Provider, Or by client users as input to the service.

### Service Provider Registration Module

The Service Providers registration module allows Service Providers to easily register and be recognized as a service provider. This enables all types of businesses, organizations and individuals to make their extended services trackable over mobile devices of targeted client users.

Service providers can register and operate using a wide range of desktop computers, laptops, handheld and mobile devices.

FIG. 2 Shows the Service Providers registration screen of the system.

### Service Definition and Configuration Module

Service Providers can define and configure various services they offer to their client users. Each service is identified by a Service Name, and a description. The service can be configured with following components:
1. Service States: describes a state in the process of fulfilling the service to a client user. A State is configured with following characteristics:
   a. Status Name:
   b. Schedule Type: indicates the schedule type for this state.
      A schedule type can be:
         i. Open: can be fulfilled anytime based on the work and input from the service provider or client user.
         ii. Fixed time: this state should be designated with a specific date and time for its completion.
         iii. Fixed Duration: this state is expected to last for the specified duration.
2. Action: which is associated to specific status, and will transform a service from one state to another.
One or more actions are associated with a specific Status.
An Action is identified by following characteristics:
   a. Action Name:
   b. Target Status:
   c. Actionable By: which indicates who can carry out that action. An Action can be carried out by an Operator of the Service Provider, And/Or Client user.

By default, each services is automatically assigned an Initiate and Complete states.

The service integrity verification check will verify that a valid path of actions will exists to progress a service from the Initiate state to the Complete state. Such check will also verify that no action path will lead into locked state, and ensures that a path leading to service completion exists from all states in the service.

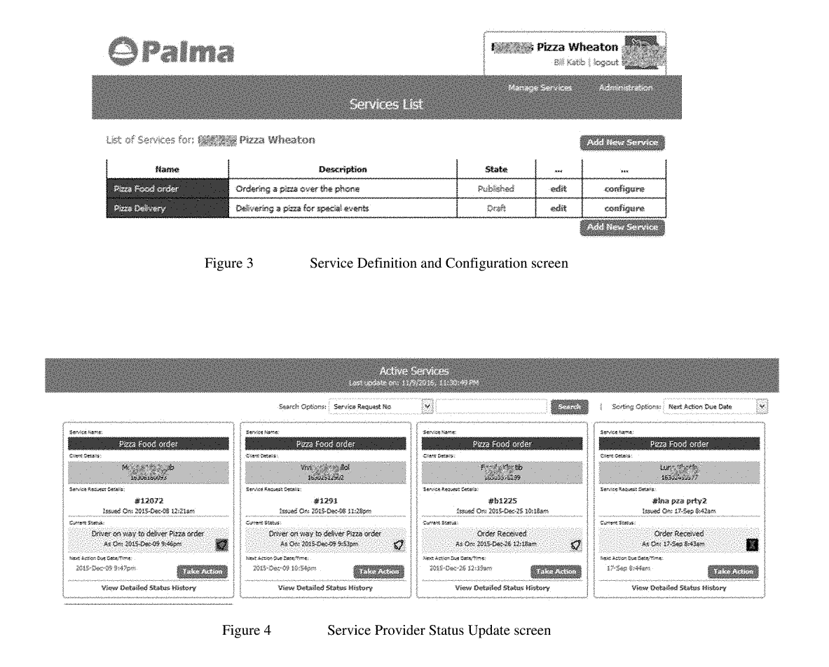

FIG. 3 shows the Service Definition and Configuration screen.

New Service Request initiation Module

An Operator of a Service Provider can initiate a new service request. The Operator will specify the following information when initiating a new service:
1. Service Name: select which service is this new instance associated with.
2. Client user identification: indicate the client user associated with this service instance. A client user is identified by their mobile telephone number. Client users can also be identified using client user account names.
   For Public services, no client user identification is necessary.
3. Service Reference No.: is optionally designated by service providers, and is used to reference such service instance with client users.

### Active Service Display and Status Update Module

Displays all active services of the Service Provider.

For each service, the following details are displayed:
1. Service Name
2. Request Ref#
3. Issue Date: the date and time that this service request was initiated.
4. Client user Name
5. Client user Telephone number
6. Current Status: showing the current state, and the date/time that the service entered this state.
7. Next Action Due Date/Time: if applicable, this shows the due date/time of the next action to be carried out to progress this service request.

### Service Status Details:

A service provider can select to display full status history of this service request. The Service Status Details will display a list of all states that the service instance went through, and the actions applied at each state. It will display the states, date-stamp of when the action was taken, and any comments entered along with the action.

States are displayed in reverse chronological order in order to provide historical flow of the progress.

### Taking Action:

The “Take Action” function can be invoked by a user to carry out a status update on the current State.

Once invoked, the “Service Action” screen will prompt the Operator with all valid actions to be applied on current state.

It also enables users to enter any special comments/remarks related to this service instance.

Once an Action is selected, the State of the service request is transformed to the target state of the action, and is reflected on all displays of service request statuses.

FIG. 4 show Service Provider Status Update screen.

### Service Status and History Details Module

Display completed service requests for a service provider. These are service instances with current state indicated as “Complete”.

For each Complete service, the following details are displayed:
1. Service Name
2. Request Ref#
3. Issue Date: the date and time that this service request was initiated.
4. Client user Name
5. Client user Telephone number
6. Complete State date/time: showing the date/time of service request completion.

### Service Status Details:

A user can select to display full Status history of this Completed service request. The Service Status Details will display a list of all states that the service instance went through, and the actions applied at each state. It will display the states, date-stamp of when the action was taken, and any comments entered along with the action.

States are displayed in reverse chronological order in order to provide historical flow of the progress.

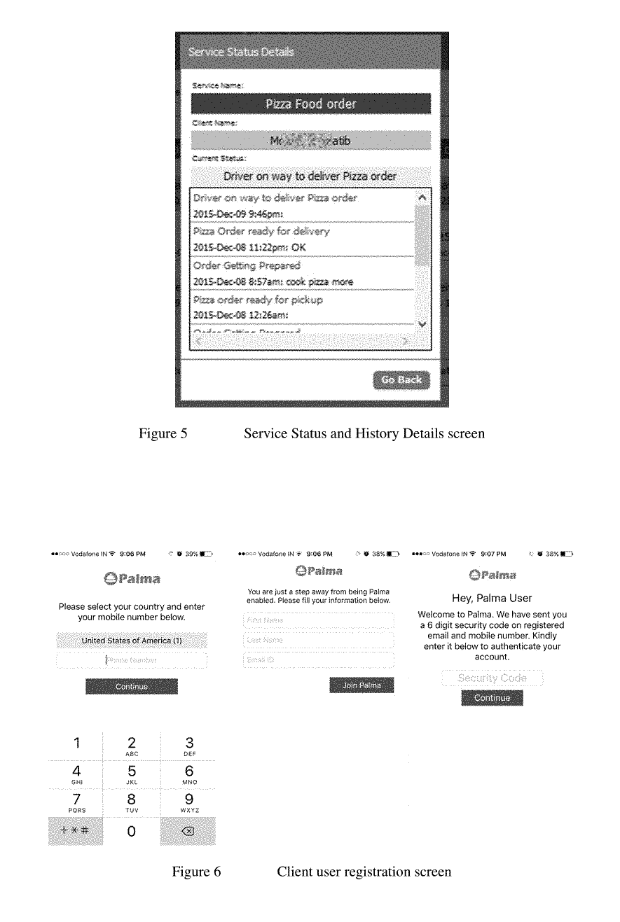

FIG. 5 shows Service Status and History Details screen.

### Client User Registration Module

This module functions on client user's mobile phone. It enables the client user to register as a user of the system.

The client user enters basic identification and demographic information.

For identification, a client user is identified by either their unique telephone number or by their unique client user name.

Client user users will select a private password to enable their secure access to the system. Client users can register using a wide range of desktop computers, laptops, handheld and mobile devices.

FIG. 6 shows Client user registration screen.

### Client User Services Status Display and Notification Module

This module displays all active service instances for the client user on his/her client application. It collects all such services from various Service Providers, and displays their status in one application.

The Active services display shows client user services, showing their latest State, and the Date/Time that entered this status.

For each service, the display presents:
1. Service Provider Logo/icon image
2. Service Provider Name
3. Name of the service
4. Latest status of the service instance
5. The Date/Time that this status was reached.

Client users can click on a service request display and the application will show full details of selected service request.

Active services can be sorted by Service Name, Service Provider Name, Initiate Date/Time, and Next Action Due Date/Time.

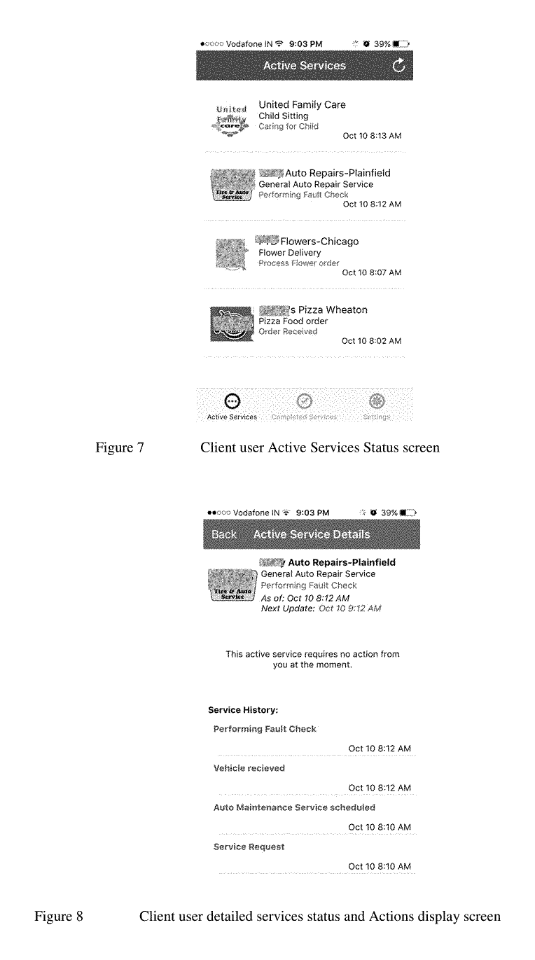

FIG. 7 shows Client user Active Services Status screen.

Client user Detailed Services Status and Actions Display Module

This module will display details about the selected service for this client user. The display will show:
1. Service Provider Logo/icon image
2. Service Provider Name
3. Name of the service
4. Current State:
   a. Status Name
   b. If applicable: the due date for next status action.
   c. If applicable, shows available client user actions on this current state
5. Service History: showing prior states and actions of this service instance. States are displayed in reverse chronological order in order to provide historical flow of the progress. For each state, it shows the state name, date-stamp of when the action was taken, and any comments entered along with the action.

FIG. 8 shows Client user detailed services status and Actions display screen.

Client user Completed Services Module

This module will list all completed services for this client user. The listing is presented in reverse chronological order.

For each service, the display presents:
1. Service Provider Logo/icon image
2. Service Provider Name
3. Name of the service
4. Service status: Completed for this service instance
5. The Date/Time that this service was completed.

Completed services listing can be sorted by Service Name, Initiate Date/Time, Completed Date/Time, and Service Provider name.

Client users can click on a completed service and the application will show full details of the history of selected service request.

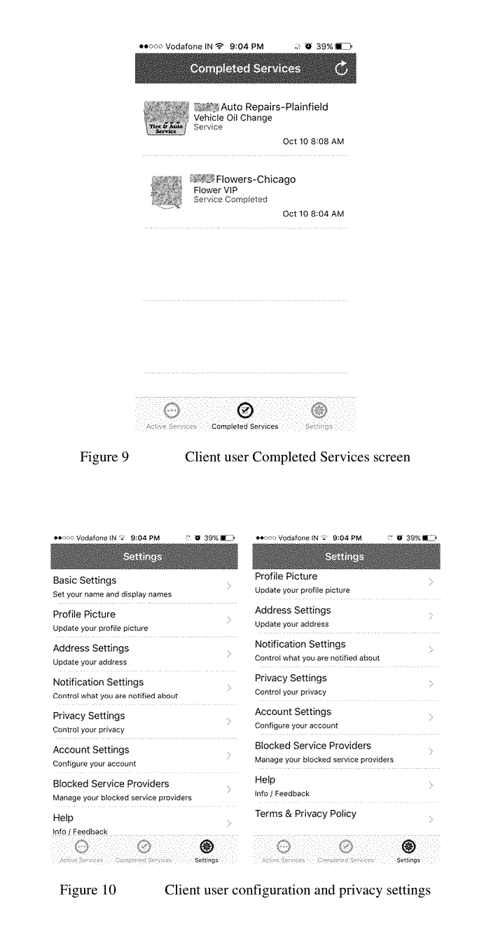

FIG. 9 shows Client user Completed Services screen.

### Client User System Configuration Module

This module enables client users to configure the setup of the application on their client side.

For each client user application environment, client users can configure their views of the system, and enter privacy settings for views and notification levels.

FIG. 10 shows Client user configuration and privacy settings screen.

In addition, within the client user configuration module, client users can block unwanted service providers, and provide feedback.

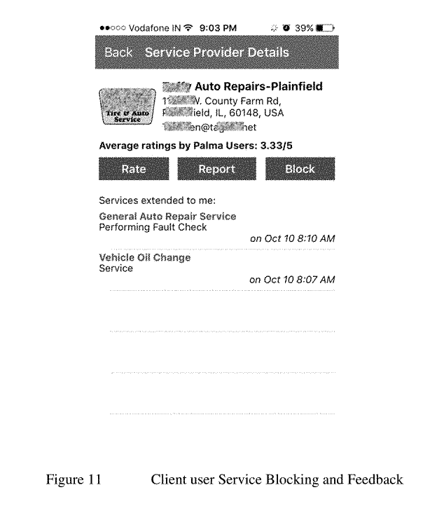

FIG. 11 shows Client user Service Blocking and Feedback.

We claim:

1. A method for representing and delivering client user service statuses, comprising:
a universal services model that represents all types of services provided by service providers to client users;
a services provider data model for representing services providers as providers of services modeled using the universal services model;
a client user data model for representing client users as recipients of services modeled using the universal services model;
for service providers,
initiating client user services that are based on the universal services model; and update service statuses; and
for client users,
tracking service status; and provide status updates and interactions applicable to their services.

2. The method of claim 1, wherein the universal services model defines a service as value added set of activities, involving one or more client users, and resulting in fulfillment of client user requirements.

3. The method of claim 1, wherein the universal services model defines a service status as the state for a service which describes the state in the process of fulfilling required client user service.

4. The method of claim 1, wherein the universal services model defines a service action as any valid action that can be carried out on a service state, to transform a service from one valid state to another.

5. The method of claim 1, wherein the universal services model enables tracking of service statuses.

6. The method of claim 1, wherein the universal services model allows service actions to be carried out by service providers, and by client users as input to the service.

7. The method of claim 1, wherein the universal services model includes a service integrity verification process that will check and verify that no action path will lead into a locked state, and ensures that a path leading to service completion exists from all states in the service.

8. A client user application for tracking service statuses, comprising:
a user registration module to register client users and enter their basic identification and demographic information;
an active services status display module that collects all services of the client user from various service providers, and displays all active service instances on the client user's mobile device;
a detailed service status display and actions module that will display details about the selected service for a client user; and
a completed services display module that will list all completed services for this client user.

9. The client user mobile application of claim 8, wherein the user registration module enables client users to be identified by either their unique telephone number, email address, or by their unique client user name.

10. The client user mobile application of claim 8, wherein the detailed service status display and actions module displays prior states and actions of this service instance, and provides chronological flow of the progress of this service.

11. A service providers application to initiate and update status of services they provide to their client users, comprising:
a service provider registration module that enables all types of businesses, organizations, groups and individuals to register and be recognized as service providers, and make their extended services trackable over mobile devices of targeted client users;
a service definition and configuration module that enables service providers to define and configure various services they offer to their client users;
a new service initiation module that enables service providers to initiate a new service instance to a specified client user;
an active service display and status update Module that displays all active services of the service provider, and enables service providers to take appropriate service actions to transform service status from one state to another; and
a service status and history details Module which displays completed service requests for a service provider.

12. The service provider application of claim 11, wherein the service definition and configuration module allows service providers to configure each services with a service state that describes the state in the process of delivering the service to a client user, and a service action which is associated with a specific state, and will transform a service from one state to another.

13. The service provider application of claim 11, wherein the service definition and configuration module utilizes the service integrity verification process to verify that a valid path of service actions exists that progress a service from any state of a service leading to complete the delivery of the service.
